(19) United States
(12) Patent Application Publication
(10) Pub. No.: US 2010/0037765 A1
(43) Pub. Date: Feb. 18, 2010

(54) METHOD FOR THE PRODUCTION OF A PISTON OF AN INTERNAL COMBUSTION ENGINE IN ORDER TO FORM A REINFORCEMENT OF A COMBUSTION CHAMBER CAVITY OF THE PISTON

(75) Inventors: Volker Gniesmer, Alfeld (DE); Gerhard Luz, Nordheim (DE); Michael Albert Janssen, Mosbach (DE); Jochen Müller, Neuenstein (DE)

Correspondence Address: YOUNG BASILE, 3001 WEST BIG BEAVER ROAD, SUITE 624, TROY, MI, 48084, US

(73) Assignee: KS KOLBENSCHMIDT GMBH, Neckarsulm (DE)

(21) Appl. No.: 11/718,300

(22) PCT Filed: Oct. 25, 2005
(86) PCT No.: PCT/EP05/11434

§ 371 Date: May 9, 2007

(30) Foreign Application Priority Data
Oct. 30, 2004 (DE) 10 2004 052 777.6
Jul. 22, 2005 (DE) 10 2005 034 306.6

(51) Int. Cl. F16J 1/00; B23P 15/10

(52) U.S. Cl. 92/172; 29/888.04

(57) ABSTRACT

A method for producing a piston of an internal combustion engine in which a first blank and at least one additional black are provided with a somewhat cylindrical shape. The blanks are joined together, and the obtained piston blank is subjected to a shaping process in which a combustion chamber cavity of the piston is formed in the area of a joining point between the first and the second blank. The material of the second blank forms a reinforcement for at least the combustion chamber cavity.

### BACKGROUND

The invention relates to a method for the production of a piston of an internal combustion engine.

In a method for the production of a piston of an internal combustion engine a first and at least one additional blank are brought to an approximately cylindrical shape. The division into at least two blanks has the purpose that the second blank which later forms the piston crown in the finished piston is easily accessible for machining to introduce a cooling channel. Only after this second blank has been machined it is joined to the first blank, machined further so that a piston blank is created and only then finish machined. In this method of production, a combustion chamber cavity or bowl is also introduced but which does not have any reinforcement so that it is no longer adequate for the demands of modern internal combustion engines, in particular with respect to the required injection pressures and combustion temperatures.

In addition to this method of production, pistons are formed with a combustion chamber cavity which has a reinforcement in the lateral area or a complete reinforcement so that the piston crown is not damaged particularly in the area of the combustion chamber cavity because of the prevailing injection pressures and combustion temperatures and the life of the piston is increased. Such a reinforcement of the combustion chamber cavity is known, for example, from DE 103 34 476 in which a piston blank is produced and the reinforcement must then be inserted and attached as a separate part. This has disadvantages in the production of the piston, in particular in series production since several parts are required for the production of the reinforcement which have to be joined in several operational steps, inserted and then machined.

A method for producing a piston is known from DE 103 15 415 in which a lower piston part is preformed and then a similarly preformed part for a later reinforcement is welded on. In the process, the part for the later reinforcement is inserted between two basic parts and then, after the joining process, this part for the later reinforcement is separated and the piston blanks thus resulting are subjected to fine machining. Thus the part for the later reinforcement is attached to the lower part of the piston only by a joining process so that no adequate strength is created between these two parts, in particular because the two materials have different coefficients of thermal expansion.

It would be desirable to provide a method for the production of a one-piece piston of a combustion engine and a piston which avoids the disadvantages described above. In particular, the reinforcement for the combustion chamber cavity should be produced simply and durably and the strength of the piston retained or improved.

### SUMMARY

A method provides for piston blanks to be joined after they are produced and the piston blank formed in this way undergoes a shaping process by which a combustion chamber cavity for the piston is formed in the area of a joint between the first blank and the second blank and the material of the second blank forms a reinforcement for at least the combustion chamber cavity. This manufacturing method has the advantage that only the first blank and the additional blank are joined to form a one-piece piston blank which, as will still be discussed, already contains the material for the reinforcement of the combustion chamber cavity of the finished piston. The one-piece piston blank can then undergo a shaping process which is advantageously a forging process in order to form a combustion chamber cavity in the piston crown area of the piston blank. In this process, the materials of the first and of the least one additional blank are shaped in the area of the joint such that not only the combustion chamber cavity is formed but the material of the second blank simultaneously forms the reinforcement of the combustion chamber cavity. Thus, fewer steps and parts overall are required for the production of the piston with the combustion chamber cavity and its reinforcement than with known manufacturing methods.

In a refinement of the method, the joining process is a friction welding process which can be used easily in the case of the two blanks which have a somewhat cylindrical shape before they are joined. Friction welding has the additional advantage that the structure of the two blanks in the area of the joint ensure adequate strength for the later piston.

In another refinement of the method, the shaping process for the one-piece blank is a forging process. Forging has the advantage that the material structure is affected positively during the shaping so that in spite of the shaping process the necessary strength of the piston blank is retained.

A piston, which is produced following the method is prepared for a combustion engine which is clearly improved not only with respect to its manufacture but in regard to its properties. Through the joining of the two blanks and the subsequent shaping, a piston of a combustion engine is available in which in the area of the piston crown at least the combustion chamber cavity but also in the area beyond it (towards the combustion chamber of the cylinder of the combustion engine) demonstrates the required resistance and strength at the injection pressures and combustion temperatures of modern combustion engines. As a result of this piston, its life is substantially increased.

### BRIEF DESCRIPTION OF THE DRAWING

One aspect of the method for the production of a piston of a combustion engine is described hereinafter and explained using the figures, although the method is not restricted to this aspect:

FIG. 1 shows a first and second piston blank before being joined;

FIG. 2 shows a first and second blank after being joined;

FIG. 3 shows a first and second blank from FIG. 2 in cross-section after being joined; and

FIG. 4 shows a view of an upper part of a finished machined piston.

### DETAILED DESCRIPTION

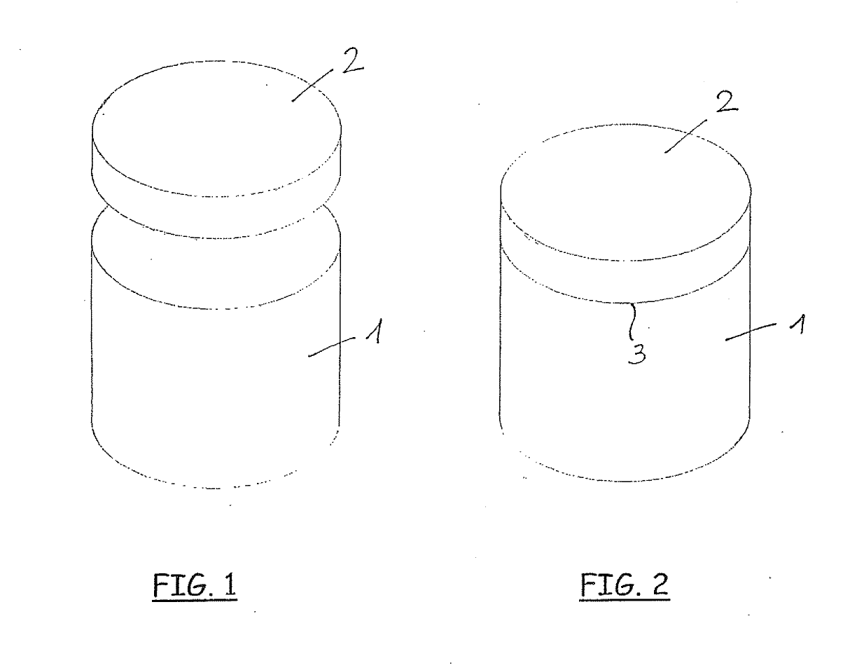

FIG. 1 shows a first blank 1 and second blank 2 before they are joined. The two blanks 1, 2 have a somewhat cylindrical shape the diameter of which corresponds approximately (somewhat oversized) to the later, finished piston. While the first blank 1 is dimensioned such that it forms the later lower part of the finished piston, the second blank 2 (cylindrical, here somewhat disc-shaped) is dimensioned such that it forms the later crown of the piston.

In order to produce a steel piston of a combustion engine, the material of the first blank 1 consists of piston steel, such as micro-alloyed steel or 42 CrMo 4. The second blank 2 consists of a high-temperature resistant steel which has properties such that it can withstand the injection pressures and the combustion temperatures to which it will be exposed later.

Two blanks are shown in FIG. 1, where the manufacturing process and the later, finished piston is not restricted to two blanks but more than two blanks can be used depending on requirements and geometric construction of the piston.

FIG. 2 shows the first blank 1 and the second blank 2 after being joined which are solidly joined to each other in the area of a joint 3 by means of a suitable joining process, such as friction welding. The joining process is selected as a function of the materials being used for the two blanks 1, 2 as well of their geometric shape.

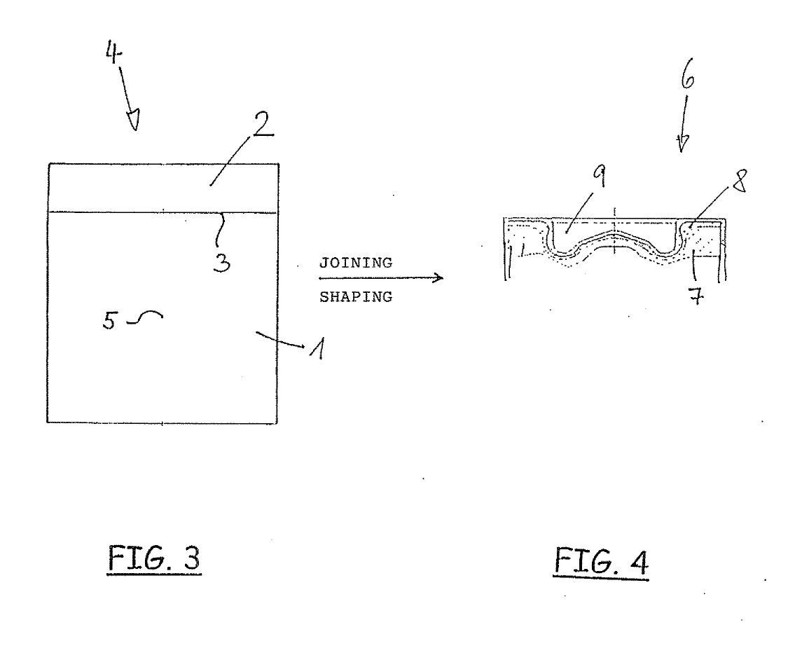

FIG. 3 shows the first blank 1 and the second blank 2 in cross-section after being joined, where the part formed is designated as piston blank 4. The basic shape of the piston blank is recognizable in the section, which forms the finished piston after it has been machined. To clarify this, an additional piston stroke axis is given reference numeral 5.

FIG. 4 shows a view of an upper part (upper area) of a finished, machined piston 6. Here it is clearly recognizable that the piston blank 4 from FIG. 3 has undergone a shaping process, specifically a forging process, as the result of which the two blanks 1, 2 have been shaped in the area of the joint 3 such that the first blank 1 has become a base body 7 and the second blank 2 a reinforcement 8 of a combustion chamber cavity 9. In the case of this aspect it is shown that not only the combustion chamber cavity 9 is provided with the reinforcement 8 but the upper face of the piston 6. Depending on the initial geometry of the second blank 2 and the subsequent shaping, only the combustion chamber cavity 9 may be provided with the reinforcement 8, but not the face of the piston 6. After the piston blank 4 from FIG. 3 has been brought to the geometric shape in accordance with FIG. 4, it still has the form of a blank, that is to say, further machining is required. After this further machining has taken place, carried in particular by metal-removing machining, the piston 6 has achieved its finished contour and is ready for installation in the combustion engine.

Although not shown in the drawing, the piston 6 has, besides the combustion chamber cavity 9, additional geometries required for operation which are known per se, such as a piston boss, a piston pin bore, a ring belt, and a cooling channel as required. These geometres needed for later operation of the piston 6 can be provided in a suitable manner with the blanks 1, 2 or with the piston blank 4. Thus it is conceivable in the case of the piston blank 4 from FIG. 3, for example, that the lower part of the piston blank 4 (in the area of the first blank 1) is shaped at least partially as a hollow cylinder in order to be able to produce the piston skirts more easily during the shaping.

In the case of the method to produce the piston and also in the case of the piston itself, its construction is not important so that the method can be used without additional difficulty for one-piece pistons and for multi-piece pistons (in particular articulated pistons).

Looking at FIG. 4, it should be pointed out in conclusion that the shaping process, in particular the forging, must be such conceived in such a way that a forged blank (shaped piston blank 4) results which has the material of the second blank 2, the high-temperature resistant steel, in the piston crown area, or in the piston bowl area respectively, and below that (in the area of the base body 7) the material of the first blank 1 (the piston steel).

Thus far it has been assumed that the at least two blanks are joined together by means of friction welding. As a further, extensive joining process, blast welding can also be used in which an explosive is inserted between the facing surfaces of the blanks and is then detonated. As a result of this explosion, the two blanks are joined together completely. In place of a surface joining process, joining processes are also conceivable in which the two blanks are joined at several places punctiform or partially. The strength required for the connection between the two blanks is achieved by the subsequent forming process where the effect of the forming process is that the two adhering blanks are connected permanently over a broad area. Independently of whether the two blanks are joined together punctiform, over a partial surface or a full surface, an additional connection is made in the subsequent shaping process so that as a result of the joining process and the subsequent forming process the necessary joint is made between the first and the additional blank.

As already described, the shaping process involves in a particularly advantageous way a forging process since the connection between the two blanks is clearly enhanced by forging. This is especially important and of advantage when the materials of the two blanks have different coefficients of thermal expansion. In the shaping process in which the piston blank 4 from FIG. 3 is brought to the later shape from FIG. 4, it can also involve metal-removing machining as an alternative or as a supplement to the shaping process by forging, in which the form of the later piston is shaped. Similarly, consideration can also be given to preforging the combustion chamber cavity 9 and then performing metal-removing fine machining whereby the later, that is to say finished, contour of the combustion chamber cavity 9 with its reinforcement is formed. Accordingly it is conceivable to subject this area or the entire piston 6 to heat treatment to increase its strength.

In addition to the materials already mentioned for the second blank, valve steels such as X45CrSi93 can also be considered which have the necessary strength for the reinforcement. Austenitic CrNi steels (for example, X12CrNi2521), austenitic-ferrous steels or high-temperature resistant steels (such as X20CrMoW12 1 or X12NiCrSi 35-16) can also be used.

While it is shown in FIG. 4 that by means of the second blank 2 the later reinforcement 8 is achieved which covers the combustion chamber cavity 9 and the face of the piston 6, it is conceivable that the second blank 2 is designed and shaped in such a way that the reinforcement 8 also includes the side surfaces of the later piston 6, in particular in the area of the ring belt. In one aspect, blank 2 can be selected in its dimensions and shaped later in such a way that the entire skirt of the piston 6 is provided with a reinforcement 8.

Furthermore, consideration can also be given to using more than two blanks 1, 2 to form an intermediate layer between the high-temperature resistant blank 2 and the blank 1 consisting of piston steel which in particular can equalize the different coefficients of thermal expansion of the two blanks 1, 2.

Finally, it should be pointed out that a blank 1 can first be joined to with the blank 2, in particular in disc form, and then an additional blank similar to blank 1 is joined to the open face of blank 2. Such a sandwich-construction piston blank is then sawed apart approximately in the center of blank 2, for example, so that afterwards two piston blanks 4, such as shown in FIG. 3, are available for additional shaping. Such a method is useable for the joining process since blank 2 has adequate depth for chucking the tool for friction welding and subsequently the piston blank thus formed with the additional blank 1 has the necessary dimensions for chucking the tool for the further friction welding process. This allows material to be saved since blank 2 can be used for two later piston blanks 2.

While it has been assumed in the prior description and the drawing that the two blanks 1, 2 have a somewhat cylindrical shape, the shapes can also deviate therefrom so that, for example, blank 2 can have a larger or smaller diameter than blank 1, where the larger diameter is used when the later reinforcement 8 is drawn around the piston crown towards the ring belt. If only the combustion bowl is to be reinforced, it is sufficient if the diameter of blank 2 is smaller than that of blank 1. In addition, blank 1 can undergo pre-processing, in particular an internal space to create the later piston skirts for example. It is desireable that the face of blank 1 which points towards blank 2 remain planar. Other geometric shapes are also conceivable in addition to the cylindrical shapes mentioned, in particular for blank 2.

1. A method for the production of a one-piece piston of a combustion engine comprising the steps of:
bringing a first blank at least one additional blank into a generally cylindrical shape,
joining the blanks by means of a friction welding procedure;
forming a piston blank that undergoes a shaping process;
implementing the shaping process as a forging process with which a combustion chamber cavity of a second piston is formed in the area of a seam between the first blank and the second blank and the material of the second blank forms a reinforcement at least for the combustion chamber cavity.

2.-3. (canceled)

4. A piston produced in accordance with the method of claim 1.

5. The piston of claim 4, characterized in that the first blank consists of a piston steel and the second blank consists of a high-temperature resistant steel.
